(19) United States
(12) Patent Application Publication
(10) Pub. No.: US 2007/0005725 A1
(43) Pub. Date: Jan. 4, 2007

(54) METHOD AND APPARATUS FOR BROWSING NETWORK RESOURCES USING AN ASYNCHRONOUS COMMUNICATIONS PROTOCOL

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/160,612

(22) Filed: Jun. 30, 2005

(51) Int. Cl. G06F 15/16

(52) U.S. Cl. 709/218

(57) ABSTRACT

A method and system are described for browsing network resources using an asynchronous communications protocol. According to an exemplary embodiment, a method in a client is described for receiving an identifier of a tuple associated with a network resource, the tuple including information related to the resource and a link to other information related to the resource. The identifier is used for requesting a subscription to the tuple associated with the network resource. A notification is received including the information related to the network resource and the link based on the subscription to the tuple associated with the network resource.

### RELATED APPLICATIONS

The present application is related to co-pending U.S. patent application Ser. No. 11/160,157, entitled “METHOD, SYSTEM, AND DATA STRUCTURE FOR PROVIDING A GENERAL REQUEST/RESPONSE MESSAGING PROTOCOL USING A PRESENCE PROTOCOL,” filed on Jun. 10, 2005, and assigned to the assignee of the present application. The present application is also related to co-pending U.S. patent application Ser. No. 11/118,882 entitled “SYSTEM AND METHOD FOR UTILIZING A PRESENCE SERVICE TO ADVERTISE ACTIVITY AVAILABILITY,” filed on Apr. 29, 2005, and assigned to the assignee of the present application. The present application is also related to co-pending U.S. patent application Ser. No. 11/096,764, entitled “SYSTEM AND METHOD FOR UTILIZING A PRESENCE SERVICE TO FACILITATE ACCESS TO A SERVICE OR APPLICATION OVER A NETWORK,” filed on Mar. 31, 2005, and assigned to the assignee of the present application. The present application is also related to co-pending U.S. patent application Ser. No. 10/960,365, entitled “SYSTEM AND METHOD FOR UTILIZING CONTACT INFORMATION, PRESENCE INFORMATION AND DEVICE ACTIVITY,” and co-pending U.S. patent application Ser. No. 10/960,135, entitled “SYSTEM AND METHOD FOR UTILIZING CONTACT INFORMATION, PRESENCE INFORMATION AND DEVICE ACTIVITY,” both filed on Oct. 6, 2004, and both assigned to the assignee of the present application. The present application is also related to co-pending U.S. patent application Ser. No. 10/900,558, entitled “SYSTEM AND METHOD FOR PROVIDING AND UTILIZING PRESENCE INFORMATION,” filed on Jul. 28, 2004, and assigned to the assignee of the present application. The present application is also related to co-pending U.S. patent application Ser. No. 10/903,576, entitled “SYSTEM AND METHOD FOR HARMONIZING CHANGES IN USER ACTIVITIES, DEVICE CAPABILITES AND PRESENCE INFORMATION,” filed on Jul. 30, 2004, and assigned to the assignee of the present application. Each of the above-cited related applications is incorporated here by reference in its entirety.

### BACKGROUND

Today's more popular browsers, such as MICROSOFT'S INTERNET EXPLORER and MOZILLA FOUNDATION'S FIREFOX, use synchronous communications protocols, such as the HyperText Transport Protocol (HTTP), to exchange information over the Internet. With a synchronous communications protocol, one entity in a network (e.g., the browser) makes a connection to another network entity (e.g., a web server), sends a request to the other entity, then waits for a reply before sending additional requests.

Synchronous communications protocols work well for supporting certain browsing tasks, such as when the browser sends a request to the web server for a web page, and then waits for a reply from the server to display the requested page. Other browsing tasks, however, are not carried out as efficiently using synchronous communications protocols. For example, an application, such as a web service, may need to notify the browser that an event has occurred, but does not need to wait for a response from the browser. In browsing transactions where it not necessary for the sender of information to wait for a response from the recipient of the information, it can be preferable to use an asynchronous communications protocol, such as a publish/subscribe (pub/sub) protocol or a presence protocol, to carry the transaction messages.

While current browser architectures do provide support for the polling of data through the use of scripting, these solutions can be unreliable. For example, if the recipient of a polling request becomes unavailable, an HTTP timeout will occur, causing a script error that typically results in a canceling of the polling request. Support for the various scripting languages can vary widely among the different browser clients and script versioning issues can be problematic. In addition, scripts can be used as a vehicle for introducing viruses into the browser and/or the client device on which the browser runs, leading some users to disable scripting support in their browsers.

Conventional applications or services built on asynchronous communications protocols, such as presence services, have their drawbacks as well. These applications typically require the use of their own proprietary application-specific client to support the service. For example, for a user to use an Instant Messaging (IM) service, the user must typically install a particular IM-specific client. Users typically cannot use a more generic client, such as a browser, to support presence-based service. Moreover, as the popularity of these asynchronous communications protocol-based applications or services continues to the grow, the number of application-specific clients needed will grow proportionately.

In addition to these drawbacks, current presence-based applications and/or services typically do not support links within their tuples that refer to other presence tuples. Consequently, there typically is no system in place for establishing relationships among the tuples on various presence servers. Also, standard XML linking does not define relationship types that will be useful in a presence web. Moreover, current presence clients display a limited set of data, typically one or more friends lists.

Some browser clients, such as KNOWNOW's LIVEBROWSER client, are capable of delivering notifications directly from a server to a browser with no polling. But these clients typically do not provide support for the browsing of presence servers (or pub/sub servers). Instead, these browser clients merely allow subscription based information to be presented in a web page. Typically, these browsers have accomplished this by providing an appropriate JavaScript library. But this technique can be particularly unreliable, as some browsers have scripting turned off.

Accordingly, there is a need for a generic browser client and associated techniques capable of browsing network resources using an asynchronous communications protocol.

### SUMMARY

Accordingly, a method and system are disclosed for browsing network resources using an asynchronous communications protocol. According to an exemplary embodiment, a method in a client is described for receiving an identifier of a tuple associated with a network resource, the tuple including information related to the resource and a link to other information related to the resource. The identifier is used for requesting a subscription to the tuple associated with the network resource. A notification is received including the information related to the network resource and the link based on the subscription to the tuple associated with the network resource.

According to another exemplary embodiment, a client for browsing network resources using an asynchronous communications protocol is described including a user interface component configured to receive an identifier of a tuple associated with a network resource, the tuple including information related to the resource and a link to other information related to the resource. A protocol agent component coupled to the user interface component is configured to use the identifier for requesting a subscription to the tuple associated with the network resource and is configured to receive the information related to the network resource and the link based on the subscription to the tuple associated with the network resource. A communications protocol stack component coupled to the protocol agent component is configured to allow the protocol agent component to request the subscription to the tuple associated with the network resource and receive the information related to the network resource and the link using an asynchronous communications protocol.

According to yet another exemplary embodiment, a server is described for allowing for browsing network resources using an asynchronous communications protocol. The server includes at least one network resource; a resource agent component coupled to the network resource configured to receive a notification to publish information related to the resource and a link to other information related to the resource to a tuple associated with the resource and to publish the information and the link based on a subscription to the tuple; and a communications protocol stack component coupled to the resource agent component configured to allow the resource agent component to receive the notification and publish the information related to the resource and the link using an asynchronous communications protocol.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 illustrates a detailed view of an exemplary client included in a client device of an arrangement for browsing network resources using an asynchronous communications protocol, according to an exemplary embodiment.

FIG. 2 illustrates exemplary protocol agent and content handler components included in the client of the client device included in the arrangement for browsing network resources using an asynchronous communications protocol shown in FIG. 1.

FIG. 3 illustrates exemplary content presentable using the client included in client device of the arrangement for browsing network resources using an asynchronous communications protocol.

FIG. 4 illustrates a detailed view of an exemplary server included in the arrangement for browsing network resources using an asynchronous communications protocol shown in FIG. 1.

FIG. 5 illustrates a tuple associated with a network resource including information related to the resource and a link to other information related to the resource, according to an exemplary embodiment.

FIG. 6 is a flowchart illustrating a method for browsing network resources using an asynchronous communications protocol, according to an exemplary embodiment.

### DETAILED DESCRIPTION

Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

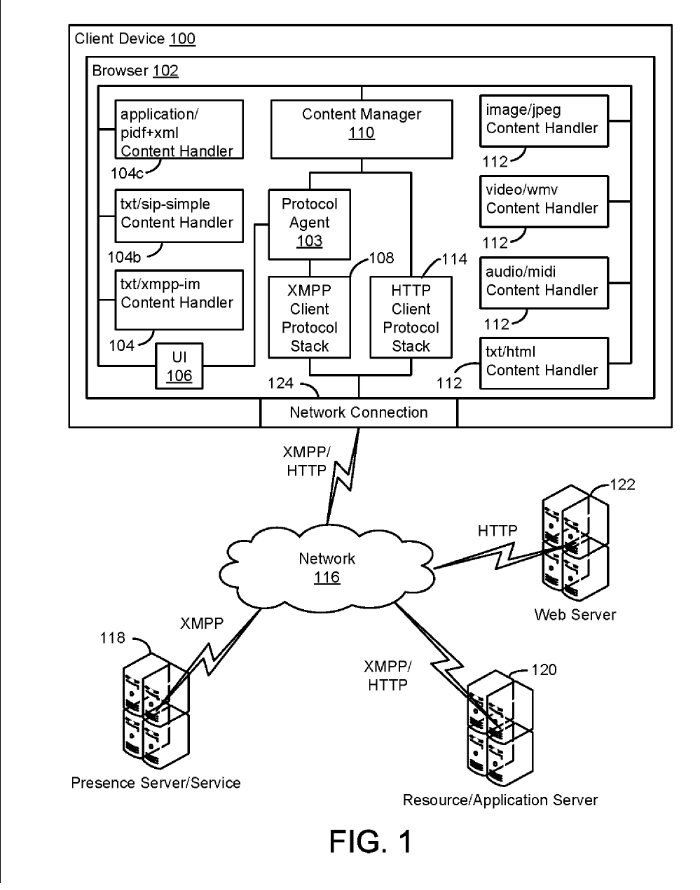

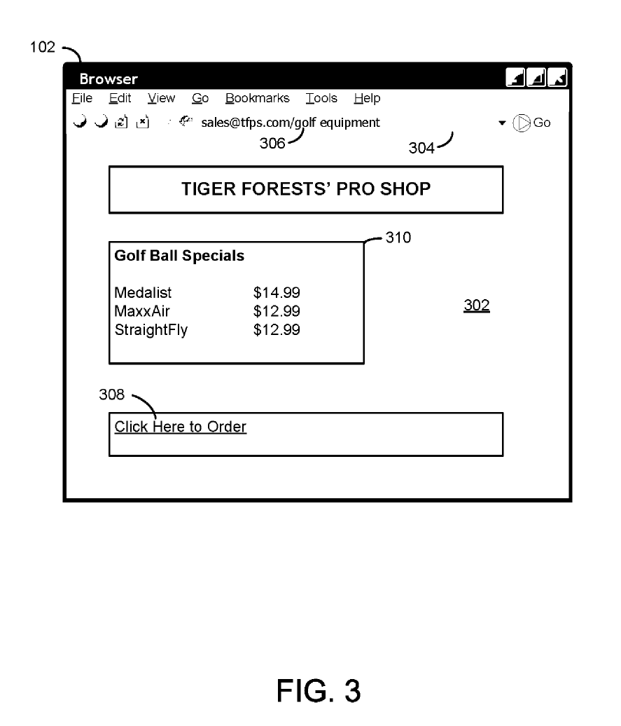

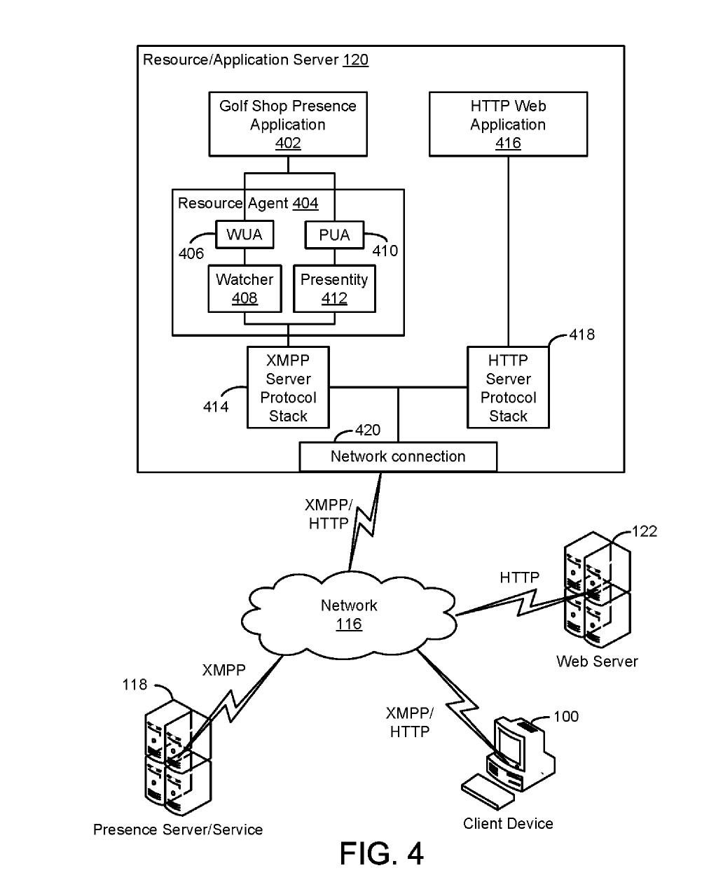

FIG. 1 illustrates a detailed view of an exemplary client included in a client device of an arrangement for browsing network resources using an asynchronous communications protocol. The client can be a browser 102, similar to MICROSOFT'S INTERNET EXPLORER or MOZILLA FOUNDATION'S FIREFOX, included in a client device 100 as shown in the figure. The client device 100 can be a Personal Computer (PC), such as the PC 100 shown in FIG. 4, or a Personal Digital Assistant (PDA), mobile telephone, network-enabled camera, camera phone, and the like. The client (or browser) includes a user interface component 106 configured to receive an identifier of a tuple associated with a network resource. For example, FIG. 3 illustrates an exemplary browser 102 having a control commonly referred to as a location bar 304. The location bar 304 can be used to enter text (e.g., using the “Go” button shown) corresponding to the identifier of the tuple associated with the network resource. In FIG. 3, the text “sales@tfps.com/golf equipment” 306 included in the location bar 304 is an identifier in the form of a Uniform Resource Identifier (URI) used to describe and/or identify the network resource 402. Alternatively, the identifier can be a link, such as the hypertext link 308 having the text “Click Here to Order” displayed in a presentation space 302 of the browser 102 shown in FIG. 3. The link can be associated with a URI corresponding to another tuple related to the resource. This other tuple could include a form object used to gather information from a user via the user interface 106 and to submit an order for merchandise.

The network resource can be anything having an identity on a network, such as the network 116 shown in FIG. 1 and 4. For example, the network resource can be a service or a program or application, such as the network applications 402, 416 included in the resource server 120 shown in FIG. 4. The network resource can also be a service, an image, a file, a document or a web page that are retrievable over the network 116, or the resource can be an entity that is not retrievable over the network 116, such as persons, companies, and written materials stored, for example, in a library or an archive.

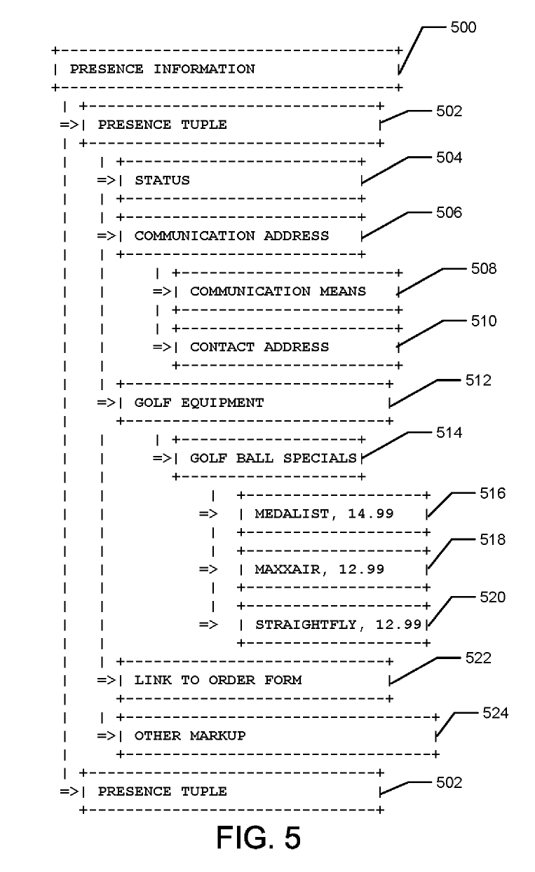

As used here, a “tuple” can be a representation that maps field names to certain values to indicate that an entity or object (e.g., the network resource) includes certain components, information, and/or perhaps has certain properties. The tuple includes information related to the resource and a link to other information related to the resource. For example, FIG. 5 illustrates an exemplary tuple 502 associated with a network resource, such as the “Golf Shop Presence Application” online store merchandising application 402 shown in FIG. 4. The information included in the tuple 502 can be exchanged via a presence service as described in greater detail below. As shown, the tuple 502 includes information stored in sub-tuples 512-520 related to the online store merchandising application 402, and includes a sub-tuple 522 including information linking the tuple 502 to another tuple (not shown) including a form associated with the online store merchandising application 402. The form can be used, for example, to gather user information and submit purchase requests via the presence service (again, as described below). The linking information included in the sub-tuple 522 can be associated with a navigable link, such as the hypertext link 308 shown in FIG. 3, to allow a user to navigate to the information included in the other tuple using the client/browser 102.

Although a presence tuple is illustrated in FIG. 5, the tuple need not be a presence tuple, per se, nor need the tuple be exchanged via a presence service. Any tuple structure can be used with the techniques described here. Moreover, persons skilled in the art will understand that the data represented by a tuple may be stored in any format, including binary data or other proprietary data formats. As such, the tuple structure simply provides the external representation of the underlying data structure of the tuple information related to the network resource. For example, a well-formed HTML document is a tuple.

The client/browser 102 shown in FIG. 1 also includes protocol agent component 103 coupled to the user interface 106. The protocol agent component 103 is configured to use the identifier for requesting a subscription to the tuple associated with the network resource. For example, the protocol agent component 103 can use the URI 306 included in the location bar 304 or the link 308 for requesting a subscription to the tuple 502 associated with the network resource 402. The subscription request can be included in a message (or command) included in an asynchronous communications protocol. The communications protocol provides a set of standard rules and commands for data representation, signaling, authentication, and error detection required to send information over a communications channel of a network. The commands of an asynchronous protocol are structured such that a sender of information via the protocol, e.g., the client/browser 102, need not wait for a response from a receiver, e.g., the server 120, after the receiver is notified of the information.

An example of an asynchronous communications protocol is a publish/subscribe (pub/sub) protocol. In a pub/sub protocol, senders of information (or publishers) post (or publish) messages with specific topics rather than sending messages to specific recipients. The pub/sub messaging system then selectively broadcasts the posted messages (through what are referred to as notify messages) to all interested parties, referred to as subscribers. The published information can be read simultaneously by any number of subscribing clients.

Other asynchronous communications protocols include presence protocols, such as those described in “Request for Comments” (or RFC) document RFC 2779 to Day et al., titled “Instant Messaging/Presence Protocol” (February 2000) and RFC 3921 to Saint-Andre, titled “Extensible Messaging and Presence Protocol (XMPP): Instant Messaging and Presence” (October 2004), each published and owned by the Internet Society. Another asynchronous presence protocol is the Session Initiation Protocol (SIP) for Instant Messaging and Presence Leveraging Extensions (or SIMPLE). SIMPLE is an application of the SIP protocol (see RFC 3261 to Rosenberg, et. al., titled “SIP: Session Initiation Protocol”; IETF, June 2002) for server-to-server and client-to-server interoperability in instant messaging. For convenience, the exemplary embodiments described here employ a presence protocol as the asynchronous communications protocol used for browsing network resources. Nevertheless, the techniques described here can be performed using any of the asynchronous communications protocols described above.

It will be understood that some presence and pub/sub protocols do provide some level of acknowledgements for the publish and notify messages sent via the protocols. Notwithstanding this, these protocols are asynchronous as between a publisher and a subscriber. That is, using the publish, subscribe, and notify commands of these protocols, a publishing entity need not wait for a reply when a notification is sent to a subscribing entity, nor does the subscribing entity need to send a request to receive information from the publishing entity.

In contrast to an asynchronous protocol, using a synchronous communications protocol, one entity in a communication network, e.g., the client 102, can make a connection to another to another entity in the network, e.g., the HTTP web server 122 shown in FIGS. 1 and 4, sends a request to the other entity, then waits for a reply to the request before continuing processing/sending other requests to the entity or other entities in the network. Many of the more widely-known communications protocols in use today operate synchronously. For example, the HTTP protocol used in exchanging information via the World Wide Web (WWW) and in providing web services is a synchronous communications protocol.

In addition to requesting a subscription to the tuple associated with the network resource, the protocol agent component 103 is also configured to receive the information related to the network resource and the link based on the subscription to the tuple associated with the network resource. For example, the protocol agent component 103 can receive a notification including the information stored in elements 512-522 of the presence tuple 502 related to the network resource 402 based on the client's/browser's subscription to the tuple 502. The protocol agent component 103 thus allows the client/browser 102 to browse resources available via the network 116, e.g., the online store application 402 hosted on the resource server 120, using an asynchronous communications protocol. The protocol agent component 103 allows the client/browser 102 to subscribe to tuples including information and a link associated with a network resource, and to receive notifications including the information and the link pursuant to the outstanding subscription.

The client/browser 102 shown in FIG. 1 also includes a communications protocol stack component, such as the XMPP client protocol stack 108 shown in the figure. The communications protocol stack component 108 is coupled to the protocol agent component 103 and is configured to allow the protocol agent component 103 to request the subscription to the tuple 502 associated with the network resource 402 and receive the information related to the network resource 512-520 and the link 522 using an asynchronous communications protocol. As understood by those skilled in the art, the communications protocol stack component 108 is used to exchange information received or transmitted at the physical layer (e.g., the wire, air interface, or fiber optic cable) of the network 116, through the data link (e.g., ETHERNET, 802.11 WIFI), transport/network (e.g., TCP/IP) and application (e.g., XMPP) layers of the stack.

Although an XMPP client protocol stack 108 is shown in the figure coupled to a corresponding XMPP-IM content handler 104 (described below), any appropriate protocol stack supporting one or more the asynchronous protocols described above or other protocols may be employed. For example, a protocol stack supporting the SIMPLE communications protocol (not shown) can be coupled to a SIP-SIMPLE content handler component 104b shown in FIG. 1 for processing SIMPLE commands. Alternatively, any CPP compliant protocol stack as specified in RFC 3859 (not shown) can be coupled to the Presence Information Data Format (PIDF) content handler 104c shown in FIG. 1 for processing CPP commands. Similarly a generic pub/sub client protocol stack (not shown) could be coupled to an appropriate generic pub/sub content handler (not shown).

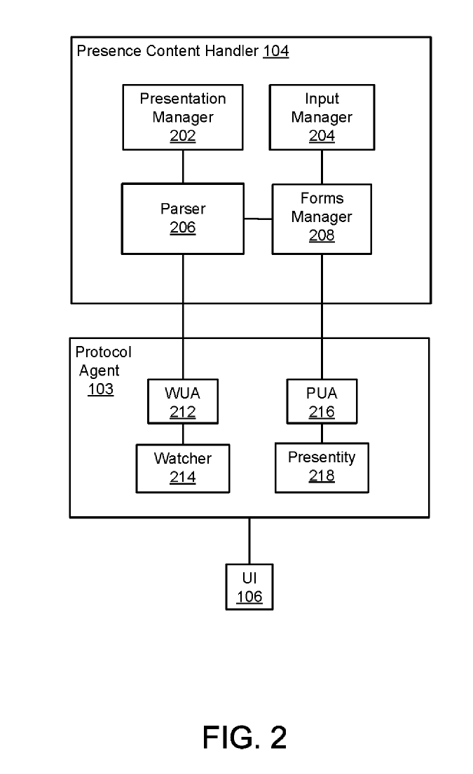

According to an exemplary embodiment, the client/browser 102 shown in FIG. 1 further includes a content handler component 104 coupled to the user interface component 106. The content handler component 104 is similar to the content handlers included in conventional browsers in that the content handler component 104 is configured to process information, e.g., the information included in the tuple 502 related to the network resource 402, based on the type of the information routed to the handler component 104. The type can be any of the number of available Multi-purpose Internet Mail Extensions (or MIME) types. For example, FIG. 2 illustrates an exemplary content handler component 104 included in the client/browser 102 configured to process information having a “txt/xmpp-im” MIME type. Similarly, the content handlers 104b, 104c are configured to process information having “txt/sip-simple” and “application/pidf+xml” MIME types, respectively. Each of these content handlers is configured to support the browsing of network resources using an asynchronous communications protocol.

According to an exemplary embodiment, the content handler component 104 includes a presentation manager component 202 configured to present at least some of the information 512-520 related to the network resource 402 and/or the link 522 in a presentation space 302 of the client 102. For example, consider that the exemplary presence tuple 502 shown in FIG. 5 is associated with an online store named “Tiger Forests' Pro Shop” that buys and sells golf equipment and perhaps offers other related services, such as providing golf lessons, organizing golf outings, and the like. The online store can host the “Golf Shop Presence Application” 402 to manage these transactions and services. The presence tuple 502 can include conventional presence information, such as a status and a communication address of the online store, stored in elements 504 and 506 of the tuple 502, respectively. The communication address can include a communication means, e.g., via client/browser 102 (other means can include email, telephony, Instant Messaging (IM), and the like) and a corresponding contact address, e.g., “sales@tfps.com/golf equipment”, for use in contacting the store via the communication means stored in element 508 and 510 of the presence tuple 502, respectively.

As shown in FIG. 5, the presence tuple 502 can also include other information related to the resource/application 402 that includes descriptions and/or related applications of golf equipment (stored in element 512), such as the prices of golf balls (stored in elements 514-520) available from the online store. The presence tuple can also include information linking the presence tuple 502 to perhaps another presence tuple (not shown) to a form object (not shown) for processing orders placed with the online store.

The presentation manager component 202 can present at least some of the information 512-520 related to the network resource/application 402 and/or the link 522 as content in a presentation space 302 of the client 102. For example, FIG. 3 illustrates exemplary content presentable using the client/browser 102 shown in FIG. 1. As shown in the figure, the name of the online store “Tiger Forests' Pro Shop” can be presented in a title portion of the presentation space 302 of the browser 102. The information included in elements 512-520 of the presence tuple 502 related to the price of golf balls available from the store can be presented in another portion 310 of the presentation space 302 of the browser. Also, the information included in the sub-tuple 522 linking the presence tuple 502 to perhaps another tuple (not shown) associated with a form object for ordering merchandise from the store can be presented as the link “Click Here to Order” 308 shown in the figure.

The presentation manager component 202 can also be configured to convert at least some of the information 512-520 related to the network resource 402 and/or the link 522 into a format usable by a principal associated with the client. Such a principal can be a person using the client/browser 102 to browse resources available via the network 116, or can be another application or program (e.g., running on the PC 100 shown in FIG. 4) configured to use the information and/or the link. Using an asynchronous protocol to exchange information between non-human principals (such as programs, services, or applications) can be an efficient arrangement for carrying out multi-party transactions. Agents can help to further improve the efficiencies in carrying out such transactions between non-human principals.

According to a related exemplary embodiment, the content handler component 104 also includes a parser component 206, coupled to the protocol agent 103, configured to receive the information 512-520 related to the network resource 402 and the link 522 and parse and/or convert the information and/or link into a format usable by the presentation manager component 202. For example, the information related to the network resource and the link can be received in an XML document. With such arrangements, the parser component 206 can be configured to use Extensible Stylesheet Language Transformations (XSLT) to transform the information related to the network resource and/or the link into a form suitable for display in the presentation space 302 of the client 102, as shown in FIG. 3. Using XSLT to transform and format XML into a presentable form is similar (at least in function) to using Cascading Style Sheets (CSS) to add styles (e.g., displaying text in a special font or color) to HyperText Markup Language (HTML) documents

According to another related exemplary embodiment, the content handler component 104 can also include an input manager component 204 configured to receive the identifier 306, 308 from the user interface component 106 in response to an entering of the identifier 306, 308 in a control component of the client, such as the location bar 304 included in the browser shown in FIG. 3, or a selection of a link displayed in the presentation space 302 of the client 102, such as the link 308 shown in the figure.

The input manager component 204 can also be configured to receive form input entered via the user interface 106 corresponding to a form field element (not shown) associated with a form object that may be included in the information related to the network resource 402 received via the communications protocol stack 108. The form object can be identified in the information stream related to the resource 402 by the parser component 206, which can then register the form object, the related form field element, and any associated actions included in the information related to processing the form object, with a forms manager component 208 included in the content handler component 104. The forms manager component 208 can be configured to manage the form object and the form field element identified by the parser component 206. In addition, the forms manager component 208 can be configured to receive the form input corresponding to the form field element from the input manager component 204, and associate the received form input with the form field element.

The skilled reader will understand that the presentation manager 202, input manager 204, parser 206, and forms manager 208 components of the client/browser 102 described above are similar to like components included in conventional browsers that exchange information with other network entities using synchronous protocols, such as HTTP, but each of the components includes enhanced functionality to support the browsing of network resources using an asynchronous communications protocol. Nevertheless, the reader is instructed to refer to information related to these like components for more detailed information related to the components 202-208 shown in FIG. 2.

FIG. 2 illustrates an exemplary arrangement of the protocol agent component 103 suitable for use when the asynchronous communications protocol used to browse the network resource is a presence protocol. With such arrangements, the protocol agent component 103 can include a watcher client 214 configured to request the subscription to the tuple 502 associated with the network resource 402. An associated watcher user agent (WUA) component 212 can be coupled to the input manager component 204 and configured to receive the identifier 306, 308 entered by a user (e.g. via an entry in the location bar 304 or via the link 308) using the user interface component 106.

The WUA can pass the identifier 306, 308 to its associated watcher component 214, which then requests the subscription to the tuple 502. The watcher component 214 can send the request for a subscription to the tuple 502 to a presence server 118 having a presence service configured to manage subscriptions throughout the network. The presence service can be hosted on a standalone server (as shown), on a number of servers arranged throughout the network, on the resource server 120, or any combination dedicated presence servers 118 and resource servers 120.

As described above, the protocol agent component 103 is configured to receive the information 512-520 related to the network resource and the link 522 based on the subscription to the tuple 502 associated with the network resource 402. For example, the watcher component 214 can also be configured to receive the notification including the information related to the network resource 402 and the link, e.g., from the presence server 118. When the subscription to the tuple 502 associated with the resource 402 is received by the presence server 118, the presence server can send a notification including the information and the link associated with the tuple 502 to the client device 100. The watcher component 214 can receive this information via the communications protocol stack 108, and the associated WUA can then pass the information and the link to the parser component 206 for processing prior to being passed to the presentation manager component 202 for display.

The exemplary protocol agent component 103 shown in FIG. 2 can also include a presentity component 218 and an associated presentity user agent (PUA) 216. The presentity/PUA 218, 216 can be configured to publish information to the presence server 118 related to the network resource. For example, the presentity/PUA 218, 216 can be configured to publish the information stored in elements 512-522 of the presence tuple 502 to the presence server 118 to advertise the services/information associated with the network resource 402 to entities that are subscribed to the tuple 502. The presence server 118 can send this information to subscribers, such as the client/browser 102, pursuant to their subscriptions to the presence tuple 502.

In addition, the presentity/PUA 218, 216 can be configured to publish the information stored in elements 512-522 of the presence tuple 502 to the presence server 118 for storage in another tuple (not shown) associated with a presence application configured to provide search services. Such a presence application can index the information included in its associated tuple (and any other linked tuples that may be defined) to provide search services to subscribing presence clients, such as the client/browser 102 shown in FIG. 1.

The presentity/PUA 218, 216 can also be configured to publish the form input received by the input manager component 204 to at least one of the tuple 502 associated with the network resource 402, another tuple associated with the link, and a tuple associated with the form object (not shown) in response to the user interface component 106 detecting an action for submitting the received form input. According to a related embodiment, the protocol agent component 103 is configured to receive a notification, e.g., via the watcher/WUA 214, 212, including a result of the form submission based on the subscription to the tuple associated with the resource.

The skilled reader will observe that the names of the components 212-218 of the exemplary protocol agent component 103 shown in FIG. 2 correspond to the components of the presence model defined in RFC 2778 to Day et al., titled “A Model for Presence and Instant Messaging” (IETF, February 2000). It should be understood that the functions of the described components 212-218, namely the publish and subscribe functions, can be incorporated into similar protocol agent components 103 to allow the client/browser 102 to browse network resources using any appropriate asynchronous communications protocol.

According to an exemplary embodiment, the client/browser 102 includes one or more additional content handler components, such as the content handlers 112 shown in FIG. 1. Each additional content handler 112 can process the information related to the network resource, such as the application 402, and other content received by the client based on a respective type the information and other content. The information type can again be any of the available MIME types, such as the “image/jpeg”, “video/wmv”, “audio/midi”, and “txt/html” types shown in FIG. 1. In a related embodiment, the client/browser 102 can also include a content manager component 110 coupled between the communications protocol stack component 108 and each of the content handler components 104, 112. The content manager component 110 can be configured to route the information related to the network resource and other content received via the stack 108 from the network connection 124 to at least one of the content handler components 104, 112 based on the type (e.g., the MIME type) of the information and other content received.

According to another exemplary embodiment, the client/browser can also include a second communications protocol stack component, such as the HTTP client protocol stack 114 shown in FIG. 1, coupled to at least one of the additional content handler components 112. The second communications protocol stack component 114 can be configured to exchange information with the at least one additional content handler component 112 using a synchronous communications protocol, such as HTTP. The second communications protocol stack component 114 is used to exchange information received or transmitted at the physical layer (e.g., the wire, air interface, or fiber optic cable) of the network 116, through the data link (e.g., ETHERNET, 802.11 WIFI), transport/network (e.g., TCP/IP) and application (e.g., HTTP) layers of the stack.

With such an arrangement, the client/browser 102 can exchange information with conventional HTTP servers, such as the web server 122 shown in FIG. 1, using HTTP, and can also exchange information with the novel resource server 120 (discussed below in conjunction with the arrangement shown in FIG. 4) using both synchronous (e.g., HTTP) and asynchronous (e.g., XMPP) protocols. Consequently, portions of the content shown in FIG. 3 can be presented/updated using conventional HTTP signaling, while other portions can be presented/updated using asynchronous (message queue) signaling (e.g., using XMPP). The novel arrangement allows both application designers and client users maximum flexibility in designing/utilizing their network services.

FIG. 4 illustrates a detailed view of an exemplary resource server 120 included in the arrangement for browsing network resources using an asynchronous communications protocol shown in FIG. 1. The server allows for the browsing of network resources using an asynchronous communications protocol. The server 120 includes at least one network resource, such as the “Golf Shop Presence Application” 402 described above. The server includes a resource agent component 404 coupled to the network resource 402. Similar to the protocol agent 103 described in conjunction with the client arrangement shown in FIG. 1, the resource agent component 404 is configured to receive a notification to publish information related to the resource and a link to other information related to the resource to a tuple associated with the resource. The resource agent component 404 can also broadcast information related to the resource to all entities (e.g., subscribers and non-subscribers) to advertise the services/information associated with the network resource.

For example, the resource agent component 404 can receive a notification from the presence server 118 to publish information related to the resource 402 and a link to other information related to the resource 402 to the elements 512-522 of the tuple 502 associated with the resource 402 shown in FIG. 5. The resource agent component 404 is further configured to publish the information and the link based on a subscription to the tuple. Typically, the server will subscribe to tuple information related to transactions, such as order form information for an online purchase, and will publish information to these transaction tuples, including status information, order confirmation information, and the like. Other types of information, such as inventory information, can be published to corresponding tuples to subscribers or can be broadcast to all network entities without the need to first receive a notification or subscription request for the information.

The resource server 120 shown in FIG. 4 also includes a communications protocol stack component 414 coupled to the resource agent component 404 configured to allow the resource agent component 404 to receive the notification and publish the information related to the resource and the link using an asynchronous communications protocol. For example, the server 120 shown in FIG. 4 includes an XMPP server protocol stack coupled between a network connection 420 and the resource agent component 404. The communications protocol stack component 414 is used to exchange information received or transmitted at the physical layer (e.g., the wire, air interface, or fiber optic cable) of the network 116, through the data link (e.g., ETHERNET, 802.11 WIFI), transport/network (e.g., TCP/IP) and application (e.g., XMPP) layers of the stack.

In the case where the asynchronous protocol is a presence protocol, the resource agent component 404 can include a watcher component 408 and an associated WUA 406 configured to receive and process the notification from the presence server. The resource agent component 404 can also include a presentity component 412 and an associated PUA 410 configured to publish information to the presence server 118. Again, It should be understood that the functions of the described components 406-412, namely the publish and subscribe functions, can be incorporated into similar resource agent components 404 to allow the resource server 120 to allow for the browsing of network resources using any appropriate asynchronous communications protocol.

According to an exemplary embodiment, the server 120 can also include a second communications protocol stack component, such as the HTTP server protocol stack 418 shown in FIG. 4, coupled to a second network resource, such as the HTTP web application 416 also shown in the figure. The second communications protocol stack component 418 can be configured to exchange information with the second network resource 416 using a synchronous communications protocol, such as HTTP. Consequently, the resource server 120 can exchange information with conventional HTTP servers, such as the web server 122 shown in FIG. 4 and conventional HTTP clients (not shown), using HTTP, and can also exchange information with the novel client device 100 via the client 102 (discussed in conjunction with the arrangement of FIG. 1) using both synchronous (e.g., HTTP) and asynchronous (e.g., XMPP) protocols. It should be understood that while the resources/applications 401 and 416 shown in FIG. 4 are depicted as separate resources/application, the server 120 can also host composite applications that use multiple protocol stacks in an integrated fashion for exchanging information via corresponding multiple communications protocols.

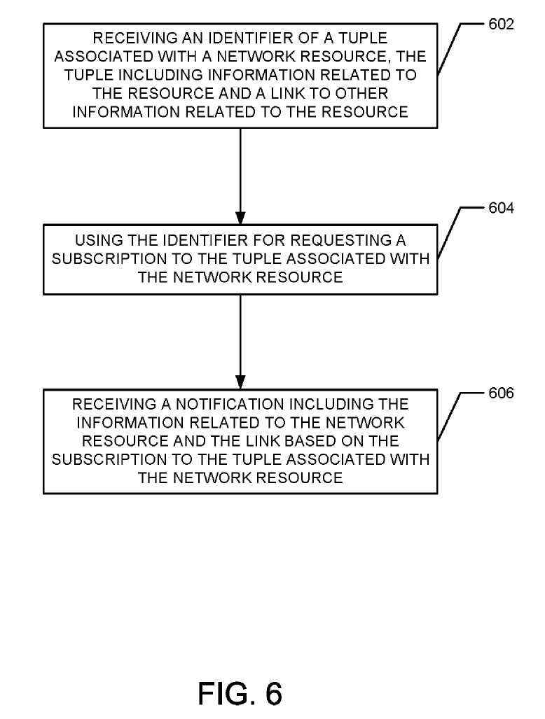

FIG. 6 depicts a flowchart illustrating an exemplary method for browsing network resources using an asynchronous communications protocol, according to an exemplary embodiment. The method can be carried out using the exemplary system depicted in FIG. 1, portions of which are referred to in the following description for illustration purposes. The reader should refer to the relevant portions of the description of the arrangement shown in FIG. 1 above for more detailed information related to the described method.

The exemplary method begins In block 602, where, in a client, such as the browser 102 shown in FIG. 2, an identifier of a tuple associated with a network resource is received, e.g., via the user interface component 106, including information related to the resource and a link to other information related to the resource. In block 604, the identifier is used, e.g., by the protocol agent component 103, for requesting a subscription to the tuple associated with the network resource. In block 606, the notification is received, by the protocol agent component 103 via the communications protocol stack component 108, including the information related to the network resource and the link based on the subscription to the tuple associated with the network resource.

According to an exemplary embodiment, the method can include presenting at least some of the information related to the network resource and/or the link in a presentation space of the client and converting at least some of the information related to the network resource and/or the link into a format usable by a principal associated with the client, e.g., using the presentation manager component 202. In a related embodiment, the presenting and/or converting is/are based on information included in the tuple associated with the network resource describing a type of the tuple. For example, the tuple 502 can include information and/or routines stored in sub-tuples (not shown) that define how the information can be presented in the browser 102 shown in FIG. 3 or converted for use by a principal associated with the browser 102.

According to an exemplary embodiment, the method can include: receiving a form object having a form field element included in the information related to the network resource, e.g., using the parser and input manager components 202, 204 of the content handler component 104; presenting the form field element in a presentation space of the client, e.g., using the presentation manager component 202 of the content handler component 104; receiving form input corresponding to the form field element, e.g., using the input manager component 204 of the content handler component 104; associating the received form input with the form field element, e.g., using the forms manager component 208 of the content handler component 104; and detecting an action for submitting the received form input, e.g., using the input manager component 204.

In a related embodiment, in response to detecting the action, the method can include publishing the received form input to at least one of the tuple associated with the network resource, another tuple associated with the link, and a tuple associated with the form object, e.g., using the protocol agent component 103. In another related embodiment, when the form input is published to the tuple associated with the network resource, the method can include receiving a notification including a result of the form submission based on the subscription to the tuple associated with the resource.

According to another exemplary embodiment, when the form input is published to the tuple associated with the form object, the method includes using an identifier associated with the form object included in the information related to the network resource for requesting a subscription to the tuple associated with the form object. A notification can be received including a result of the form submission based on the subscription to the tuple associated with the form object. The requesting of the subscription and receipt of the notification can be realized using the protocol agent component 103.

In yet another exemplary embodiment, the tuple associated with the form object can be shared between a principal associated with the client and a principal associated with the network resource. For example, the tuple associated with the form object can be shared between the online store “Tiger Forests' Pro Golf” hosting the golf merchandising application 402 and a purchaser of equipment from the online store using the browser 102.

According to another exemplary embodiment, the received form input can be sent to a network server using a synchronous communications protocol in response to detecting the action. For example, the form input can be sent to the server 120 via HTTP. With such an arrangement, the presentation/updating of online store inventories can be updated automatically using the asynchronous protocol, e.g. in the portion 310 of the presentation space 302 shown in FIG. 3, while the order can be processed using conventional HTTP forms processing. Consequently, web servers used to process such orders need not be updated/retrofitted to enable them to process transactions from clients 102 capable of browsing network resources using an asynchronous protocol.

According to an exemplary embodiment, the method includes using a link type associated with the link included in the tuple to determine a relationship between the network resource and the other information related to the resource. By associating a type with a link, the client 102 can be more capable of understanding and interpreting a relationship represented by the link. Possible link types include: “owner” indicating that the link represents an owner of the resource, “memberOf”, e.g., defining whether the link information is part of a larger set, bag, or list, and moreinfo, allowing a “web” of presence information to be created that is navigable (and interpretable by non-human agents). XML schema languages allow links to be typed and extended as may be needed. Consequently, linked or related data can be displayed in a series of linked pages using the arrangement shown in FIGS. 1 and 4 allowing users to traverse the links to see only the information of particular interest.

In another exemplary embodiment, a list of identifiers of tuples associated with a plurality of related network resources is created and/or maintained for use by the client 102 and/or server 120.

Also, an identity of the client 102 and/or a principal associated with the client 102 is/are authenticated and the requesting of the subscription to the tuple associated with the network resource and/or the receiving of the notification is/are authorized based on the authenticated identity prior to the requesting of the subscription and/or receiving of the notification by the client. The presence server 118 can include an authentication service to perform these functions. In a related embodiment, the identity of the client and/or the principal associated with the client is/are included in a tuple associated with a roster list including identities of clients and/or principals authorized to access the tuple associated with the network resource. Again, roster list can be stored on the presence server 118 to support the authentication/authorization function.

According to an exemplary embodiment, the method includes providing a synchronous communications protocol, e.g., via the HTTP client protocol stack 114 shown in FIG. 1, along with the asynchronous communications protocol for browsing the network resources.

The executable instructions of a computer program as illustrated in FIG. 6 for browsing network resources using an asynchronous communications protocol can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used here, a “computer readable medium” can be any means that can contain, store, communicate, propagate, or transport the program for use by or in connection with the instruction execution system, apparatus, or device. The computer readable medium can be, for example, but not limited to, an electronic, magnetic, optical, electromagnetic, infrared, or semiconductor system, apparatus, device, or propagation medium.

More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

### ILLUSTRATIVE EXAMPLE

The following illustrative example is provided in conjunction with arrangements depicted in FIGS. 1-4. The actions carried out in the example are for illustrative purposes, and should not be construed as being limiting in any way. Nor should the numerical order of the steps be construed as limiting or necessary in any way. The illustrative example uses a presence service, but it should be understood that other asynchronous communications protocols could be used to carry out the describe tasks.

An online shopper Bob wishes to purchase new golf balls. Bob brings up his presence browser 102 (PB) and executes a search for sporting goods or golf retailers. The PB presents a list of links to, and info from, the tuples/sub-tuples discovered using an indexing/search service. The search service can index the presence web to provide search services for the PB. The indexing/search service can build a roster of relevant links, and the PB 102 can display the status of each entity associated with a particular link in the roster. The search service can be represented by a presence tuple that is “owned” by the service itself or a service provider. Status for a particular retailer included in the displayed search results can reflect not only the retailer's operating state, but can also indicated the type of retailer, a customer satisfaction level, a size of the retailer's inventory, and the like, since status under RFC 2778 can be stored in an extendible sub-tuple.

Given that the search service is searching presence tuples built-up from specified vocabularies and ontologies, the service is able to perform more than just a keyword search. Instead, the service can accurately locate what the shopper Bob has requested based on the meaning of the various vocabularies and ontologies as well as the search terms. Requests and responses can be represented as tuple data as described in U.S. patent application Ser. No. 11/160,157, entitled “METHOD, SYSTEM, AND DATA STRUCTURE FOR PROVIDING A GENERAL REQUEST/RESPONSE MESSAGING PROTOCOL USING A PRESENCE PROTOCOL,” filed on Jun. 10, 2005, and assigned to the assignee of the present application. Tuple data can be exchanged using standard presence protocols.

Bob next selects Tiger Forests' Pro Shop (TFPS) since it has high ratings and a large inventory. The PB 102 sends a subscribe command to retrieve the tuple info on TFPS. The tuple can include information or links to other tuples/sub-tuples containing information representing the various inventory categories. For example, the sub-tuple “Golf Equipment” 512 and its associated sub-tuples 514-520 shown in FIG. 5 include the desired information regarding golf balls. Since the TFPS tuple represents an aggregate of a number of other tuples, the online shopper Bob is able to search the entire aggregation that makes up TFPS's tuple space.

Since an asynchronous protocol, such a presence protocol, is being used to browse the TFPS's tuple space, the PB 102 is able to receive notifications of changes in TFPS's inventory and update the displayed data in the portion 310 of the presentation space 302 shown in FIG. 3. If a price or inventory quantity changes, a user will see it on a PB display, without having to invoke an explicit refresh request for the data or having to using polling routines.

A merchandising application 402 hosted on TFPS's server 120 can be notified of Bob's subscription to their tuple information, and can request a subscription to Bob's tuple information (perhaps his shopping tuple) to be able to detect transaction requests from Bob.

Bob selects a “Golf Ball Specials” link and follows subsequent links until he locates a tuple for the package of golf balls he wants. Each time Bob selects a link that involves a new tuple, Bob's PB 102 subscribes to the new tuple(s) and can unsubscribe to tuples that are no longer being displayed. Alternatively, the PB 102 could maintain subscriptions for some time period, allowing Bob to revisit recently visited tuples in an efficient manner.

Bob then selects a “Click Her to Order” link 308 displayed on the presentation space 302 of the browser. This can result in a publish command being sent to the presence server 118 that creates a new order form tuple based, perhaps, on a template included in TFPS tuple. The new order form tuple can be returned to the PB 102 (e.g., via a directed notify command or pursuant to an existing subscription). The PB 102 can then display the order form information (not shown) including the item Bob wishes to purchase.

Bob can continue shopping through a link provided on the form or can indicate that he wishes to purchase twelve dozen golf balls. Bob presses the update button or link included on the order form (not shown). A publish request can be issued to process the form, which publishes the form data to Bob's tuple resulting in a notify command being sent to TFPS. TFPS can then update Bob's shopping tuple in TFPS's tuple space including any calculated order information provided by the application 402. This update results in a notify command being sent to Bob's PB 102, which can display the current shopping cart. Because TFPS is subscribed to Bob's order form tuple, the store can respond to each request made by Bob.

The order form tuple can next be updated to indicate it is now in a checkout state. Bob's order form tuple can include a link to Bob's tuple form which can include his shipping address, payment info, and the like. The order form tuple can be updated with this info via a publish command by TFPS, resulting in a notify to Bob's PB 102 directed by the presence server 118. The status of the order from tuple can now be said to be in “confirm” state. Bob next enters his pin or password into the order form and presses a submit button to complete his order. This info is passed to the presence server 118 via a publish from the PB 102 to Bob's tuple. The published information is received by TFPS via a notify command pursuant to its subscription to Bob's tuple information. After the presence server 118 verifies Bob's pin/password, the TFPS can update the status of the order to “accepted” via a publish command to the presence server 118. The presence server 118 can then update the information displayed on the PB 102 via a notify command.

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for browsing network resources using an asynchronous communications protocol, the method comprising: in a client:
receiving an identifier of a tuple associated with a network resource, the tuple including information related to the resource and a link to other information related to the resource;
using the identifier for requesting a subscription to the tuple associated with the network resource; and
receiving a notification including the information related to the network resource and the link based on the subscription to the tuple associated with the network resource.

2. The method of claim 1, comprising at least one of: presenting at least some of the information related to the network resource and/or the link in a presentation space of the client; and
converting at least some of the information related to the network resource and/or the link into a format usable by a principal associated with the client.

3. The method of claim 2, wherein the presenting and/or converting is/are based on information included in the tuple associated with the network resource describing a type of the tuple.

4. The method of claim 1, comprising:
receiving a form object having a form field element included in the information related to the network resource;
presenting the form field element in a presentation space of the client;
receiving form input corresponding to the form field element;
associating the received form input with the form field element; and
detecting an action for submitting the received form input.

5. The method of claim 4, wherein in response to detecting the action, the method comprises publishing the received form input to at least one of the tuple associated with the network resource, another tuple associated with the link, and a tuple associated with the form object.

6. The method of claim 5, wherein when the form input is published to the tuple associated with the network resource, the method comprises receiving a notification including a result of the form submission based on the subscription to the tuple associated with the resource.

7. The method of claim 5, wherein when the form input is published to the tuple associated with the form object, the method comprises:
using an identifier associated with the form object included in the information related to the network resource for requesting a subscription to the tuple associated with the form object; and
receiving a notification including a result of the form submission based on the subscription to the tuple associated with the form object.

8. The method of claim 5, wherein the tuple associated with the form object is shared between a principal associated with the client and a principal associated with the network resource.

9. The method of claim 5, wherein in response to detecting the action, the method comprises sending the received form input to a network server using a synchronous communications protocol.

10. The method of claim 1, comprising using a link type associated with the link included in the tuple to determine a relationship between the network resource and the other information related to the resource.

11. The method of claim 1, comprising using and/or maintaining a list of identifiers of tuples associated with a plurality of related network resources.

12. The method of claim 1, wherein an identity of the client and/or a principal associated with the client is/are authenticated and the requesting of the subscription to the tuple associated with the network resource and/or the receiving of the notification is/are authorized based on the authenticated identity prior to the requesting of the subscription and/or receiving of the notification by the client.

13. The method of claim 12, wherein the identity of the client and/or the principal associated with the client is/are included in a tuple associated with a roster list including identities of clients and/or principals authorized to access the tuple associated with the network resource.

14. The method of claim 1, comprising providing a synchronous communications protocol along with the asynchronous communications protocol for browsing the network resources.

15. The method of claim 14, wherein the synchronous communications protocol includes at least one of a request/response protocol and a HyperText Transport Protocol (HTTP).

16. The method of claim 1, wherein the asynchronous communications protocol includes at least one of a publish/subscribe (pub/sub) protocol, a presence protocol, an Extensible Messaging and Presence Protocol (XMPP), and a Simple Instant Messaging and Presence Protocol (SIMPLE).

17. The method of claim 1, wherein the identifier is received in response to an entering of the identifier in a control component of the client or in response to a selection of a link displayed in a presentation space of the client.

18. The method of claim 1, wherein a plurality of clients and/or associated principals each receive the notification including the information related to the network resource and the link based on respective subscriptions to the tuple associated with the network resource.

19. A client for browsing network resources using an asynchronous communications protocol, the client comprising:
a user interface component configured to receive an identifier of a tuple associated with a network resource, the tuple including information related to the resource and a link to other information related to the resource;
a protocol agent component coupled to the user interface component configured to use the identifier for requesting a subscription to the tuple associated with the network resource and configured to receive the information related to the network resource and the link based on the subscription to the tuple associated with the network resource; and
a communications protocol stack component coupled to the protocol agent component configured to allow the protocol agent component to request the subscription to the tuple associated with the network resource and receive the information related to the network resource and the link using an asynchronous communications protocol.

20. The client of claim 19, comprising a content handler component configured to process the information related to the network resource and the link based on the type of the information.

21. The client of claim 20, wherein the content handler component comprises a presentation manager component configured to perform at least one of presenting at least some of the information related to the network resource and/or the link in a presentation space of the client, and converting at least some of the information related to the network resource and/or the link into a format usable by a principal associated with the client.

22. The client of claim 21, wherein the content handler component comprises a parser component configured to perform at least one of receiving the information related to the network resource and the link, parsing and/or converting the information and/or link into a format usable by the presentation manager component, and identifying a form object having a form field element included in the information related to the network resource.

23. The client of claim 22, wherein the content handler component comprises an input manager component configured to perform at least one of receiving the identifier from the user interface component in response to an entering of the identifier in a control component of the client or a selection of a link displayed in the presentation space of the client, and receiving form input corresponding to the form field element.

24. The client of claim 23, wherein the content handler component comprises a forms manager component configured to perform at least one of managing the form object and the form field element identified by the parser component, receiving the form input corresponding to the form field element from the input manager component, and associating the received form input with the form field element.

25. The client of claim 24, wherein the protocol agent component is configured to publish the form input to at least one of the tuple associated with the network resource, another tuple associated with the link, and a tuple associated with the form object in response to the user interface component detecting an action for submitting the received form input.

26. The client of claim 25, wherein the protocol agent component is coupled to the content handler component and is configured to receive a notification including a result of the form submission based on the subscription to the tuple associated with the resource.

27. The client of claim 19, comprising one or more additional content handler components each configured to process the information related to the network resource and other content received by the client based on a respective type the information and other content.

28. The client of claim 27, comprising a content manager component coupled between the communications protocol stack component and each of the content handler components, the content manager component configured to route the information related to the network resource and other content to at least one of the content handler components based on the type of the information and other content.

29. The client of claim 27, comprising a second communications protocol stack component coupled to at least one of the additional content handler components, the second communications protocol stack component configured to exchange information with the at least one additional content handler component using a synchronous communications protocol.

30. The client of claim 29, wherein the synchronous communications protocol includes at least one of a request/response protocol and a HyperText Transport Protocol (HTTP).

31. The client of claim 19, wherein the asynchronous communications protocol includes at least one of a publish/subscribe (pub/sub) protocol, a presence protocol, an Extensible Messaging and Presence Protocol (XMPP), and a Simple Instant Messaging and Presence Protocol (SIMPLE).

32. A server allowing for browsing network resources using an asynchronous communications protocol, the server comprising:
at least one network resource;
a resource agent component coupled to the network resource configured to receive a notification to publish information related to the resource and a link to other information related to the resource to a tuple associated with the resource and to publish the information and the link based on a subscription to the tuple; and
a communications protocol stack component coupled to the resource agent component configured to allow the resource agent component to receive the notification and publish the information related to the resource and the link using an asynchronous communications protocol.

33. The server of claim 32, comprising a second communications protocol stack component coupled to a second network resource, the second communications protocol stack component configured to exchange information with the second network resource using a synchronous communications protocol.

34. The server of claim 33, wherein the synchronous communications protocol includes at least one of a request/response protocol and a HyperText Transport Protocol (HTTP).

35. The server of claim 32, wherein the asynchronous communications protocol includes at least one of a publish/subscribe (pub/sub) protocol, a presence protocol, an Extensible Messaging and Presence Protocol (XMPP), and a Simple Instant Messaging and Presence Protocol (SIMPLE).

36. A computer readable medium containing a computer program for browsing network resources using an asynchronous communications protocol, the computer program comprising instructions executable in a client for:
receiving an identifier of a tuple associated with a network resource, the tuple including information related to the resource and a link to other information related to the resource;
using the identifier for requesting a subscription to the tuple associated with the network resource; and
receiving a notification including the information related to the network resource and the link based on the subscription to the tuple associated with the network resource.

37. The medium of claim 36, wherein the computer program comprises instructions executable in the client for at least one of:
presenting at least some of the information related to the network resource and/or the link in a presentation space of the client; and
converting at least some of the information related to the network resource and/or the link into a format usable by a principal associated with the client.

38. The medium of claim 36, wherein the computer program comprises instructions executable in the client for:
receiving a form object having a form field element included in the information related to the network resource;
presenting the form field element in a presentation space of the client;
receiving form input corresponding to the form field element;
associating the received form input with the form field element; and
detecting an action for submitting the received form input.

39. The medium of claim 38, wherein in response to detecting the action, the computer program comprises instructions executable in the client for publishing the received form input to at least one of the tuple associated with the network resource, another tuple associated with the link, and a tuple associated with the form object.

40. The medium of claim 39, wherein when the form input is published to the tuple associated with the network resource, the computer program comprises instructions executable in the client for receiving a notification including a result of the form submission based on the subscription to the tuple associated with the resource.

41. The medium of claim 39, wherein when the form input is published to the tuple associated with the form object, the computer program comprises instructions executable in the client for:
using an identifier associated with the form object included in the information related to the network resource for requesting a subscription to the tuple associated with the form object; and
receiving a notification including a result of the form submission based on the subscription to the tuple associated with the form object.

42. The medium of claim 39, wherein in response to detecting the action, the computer program comprises instructions executable in a client for sending the received form input to a network server using a synchronous communications protocol.

43. The medium of claim 36, wherein the computer program comprises instructions executable in the client for using a link type associated with the link included in the tuple to determine a relationship between the network resource and the other information related to the resource.
